(19) United States
(12) Patent Application Publication
(10) Pub. No.: US 2015/0129180 A1
(43) Pub. Date: May 14, 2015

(54) HEAT EXCHANGER SYSTEM, METHOD FOR PRODUCING SAME, AND FLUID DISTRIBUTION ELEMENT

(71) Applicant: Fraunhofer-Gesellschaft zur Foerderung der angewandten Forschung e.V., Muenchen (DE)

(72) Inventors: Andreas Strehlow, Hofgeismar (DE); Birgo Nitsch, Hofgeismar (DE); Thore Oltersdorf, Freiburg (DE); Markus Werner, Chemnitz (DE)

(73) Assignee: Fraunhofer-Gesellschaft zur Foerderung der antgewandten Forschung e.V., Muenchen (DE)

(21) Appl. No.: 14/406,420

(22) PCT Filed: Jun. 7, 2013
(86) PCT No.: PCT/EP2013/061761

§ 371 Date: Dec. 8, 2014

(30) Foreign Application Priority Data
Jun. 8, 2012 (DE) 10 2012 011 520.2

(51) Int. Cl. F28D 1/053; B23P 15/26; F28F 1/02

(52) U.S. Cl. CPC F28D 1/05366; F28F 1/022; B23P 15/26
USPC 165/151; 165/174; 165/175; 29/890.047

(57) ABSTRACT

A heat exchanger system includes a fluid distribution element and a 1 pass heat exchanger. The fluid distribution element has a central inlet and fluid-sealed, channel-like fluid guide which branches into a plurality of fluid guidance channels. The 1 pass heat exchanger consists of a plurality of through-flowable tubes disposed in one plane and having planar partial faces, preferably flat tubes, and fins connected on the planar partial faces to the tubes. Each of the through-flowable tubes has a tube inlet and a tube outlet, the tube outlets opening into a fluid collection system. The fluid distribution element having the same number of fluid outlets as the 1 pass heat exchanger has through-flowable tubes and at least one of a direct connection of the fluid distribution element to the 1 pass heat exchanger or an indirect connection of the fluid distribution element to the 1 pass heat exchanger.

### CROSS-REFERENCE TO RELATED APPLICATIONS

This application is a national phase application of PCT Application No. PCT/EP2013/061761, internationally filed Jun. 7, 2013, which claims priority to German Application No. 10 2012 011 520.2, filed Jun. 8, 2012, all of which are herein incorporated by reference in their entirety.

### TECHNICAL FIELD

This disclosure relates to heat exchanger systems.

### BACKGROUND

An important parameter for assessing the efficiency of a cross-flow-operated evaporator is the optimum temperature distribution on the surface. This temperature distribution is a prerequisite for a low temperature difference between the operating media involved. This difference is termed terminal temperature difference. In order to achieve an optimum terminal temperature difference of a heat exchanger, a uniform distribution of the coolant and of the airflow on the outside is necessary. In addition to the terminal temperature difference, the pressure loss plays a role. Coolant-side pressure losses which are uniform and as optimised as possible imply a small change in the evaporation temperature and hence in turn altogether a high temperature homogeneity. This is achieved particularly well in so-called 1 pass heat exchangers in which the throughflow of the heat exchange medium through a tube register/flat tube is reduced to a single pass. The fluid distribution and the collector generally consist of simple hollow cylinders with slots or oblong holes for connection of the flat tubes. However, great problems thereby result in the fluid distribution since, according to the output of the evaporator, a variable large number of these flat tubes are used in the heat exchanger and connected to at least one distributor and also at least one collector. Both the conventionally used distributor and the collector thereby have large dead volumes, which generally causes a phase separation due to low flow velocities on the basis of the large, flowed-through cross-sections upon entry of the coolant into the evaporator. As a result of the use of flat tubes, in particular of MPE tubes, which are united per se once again in a large number of through-flowed channels, the fluid distribution must be taken into account not only for the totality of the flat tubes but also, with respect to the large number of channels, coordinated when using MPE tubes. An advantage of this heat exchanger relative to heat exchangers consisting of fin block and tube registers—normal round tube registers—is the reduction in the inner volumes. Minimisation of these inner volumes is a necessary prerequisite for coolant minimisation of refrigeration cycles. The coolant minimisation plays a central role in the applicability of combustible coolants and also in the increase in the economic efficiency of numerous, hermetic refrigeration cycles which, as a function of the filling quantity, must be maintained with varying complexity. Even with the introduction on the market and the design of soldered aluminium microchannel heat exchangers as condensers, the process starts with a reduction of approx. 40% of the inner volume, despite the volumes of the hollow cylinders used for distributor and collector being still very generous. The process starts here from further reduction potentials, which enables a further coolant minimisation.

As already mentioned, large dead volumes are the main reason for phase separation and hence poor phase distribution. Volume-displacing baffles have only a limited effect on this situation. The through-flowed volume in the distributor is furthermore coherent, which leads precisely to these dead volumes, and the greatly differing flow velocities as a result of output-controlled refrigeration cycles make optimised design even more difficult.

### SUMMARY

The present disclosure relates to at least one heat exchanger system that includes a fluid distribution element and a 1 pass heat exchanger. The fluid distribution element has cascaded possibilities for distribution of fluid flows, starting from a central inlet, the distributed fluid flows being fed into the at least one heat exchanger. In one aspect, the fluid distribution element has the same number of fluid outlets as the 1 pass heat exchanger has through-flowable tubes. The connection between fluid distribution elements and the 1 pass heat exchanger is achieved by a direct connection of the fluid distribution element to the 1 pass heat exchanger. Also, an indirect connection of the fluid distribution element to the 1 pass heat exchanger is included, each fluid outlet of the fluid distribution element being connected via a connection element to the heat exchanger. The present disclosure also relates to a method for the production of a heat exchanger system and to a specially configured fluid distribution element.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

FIG. 1 is a diagram illustrating an indirect connection of a fluid distribution element, a 1 pass heat exchanger, and a connection element for the entire 1 pass heat exchanger system, according to some embodiments described in the disclosure.

FIG. 2A is a diagram illustrating a view of FIG. 2B in the drawing plane from the left, of a schematic illustration of a 1 pass heat exchanger system, according to some embodiments described in the disclosure.

FIG. 2B is a diagram illustrating a schematic illustration of a 1 pass heat exchanger system, according to some embodiments described in the disclosure.

FIG. 3 is a diagram illustrating an exploded view of FIGS. 2A and 2B, according to some embodiments described in the disclosure.

FIG. 4A is a diagram illustrating a plan view on the 1 pass heat exchanger system, according to some embodiments described in the disclosure.

FIG. 4B is a diagram illustrating a schematic exploded view of this system, according to some embodiments described in the disclosure.

FIG. 4C is a diagram illustrating the partial assembly of the fluid distribution element and the connection elements, according to some embodiments described in the disclosure.

FIG. 5 is a diagram further illustrating the system of FIGS. 4A-4C, according to some embodiments described in the disclosure.

FIG. 6A is a diagram illustrating an exploded view of 1 pass heat exchanger system, according to some embodiments described in the disclosure.

FIG. 6B is a diagram illustrating another exploded view of a 1 pass heat exchanger system, according to some embodiments described in the disclosure.

FIG. 6C is a diagram illustrating a plan view of a 1 pass heat exchanger system, according to some embodiments described in the disclosure.

FIG. 7 is a diagram illustrating a corresponding 1 pass heat exchanger system of that described in FIGS. 6A-6C, according to some embodiments described in the disclosure.

FIG. 8 is a diagram illustrating a section of a connection of fluid outlets of a fluid distribution element to a collection box, via a collection box to a 1 pass heat exchanger, according to some embodiments described in the disclosure.

FIG. 9 is a diagram illustrating fluid guidance channels of a fluid distribution element in which the fluid outlets are inserted into the wall of the fluid guidance channel, according to some embodiments described in the disclosure.

FIG. 10 is a diagram illustrating a lower metal sheet of a fluid distribution structure, by way of example, in IHB manufacturing mode, according to some embodiments described in the disclosure.

FIG. 11 is a diagram illustrating a fluid distribution element in which nozzles are attached directly to the outlet opening of the fluid distribution channels in order to influence the fluid flow and/or the condensation or evaporation behaviour of the through-flowing fluid, according to some embodiments described in the disclosure.

FIG. 12A is a diagram illustrating an individual fluid guidance channel into which an oblong hole is introduced into the wall of the channel, according to some embodiments described in the disclosure.

FIG. 12B is a diagram illustrating a fluid guidance channel, according to some embodiments described in the disclosure.

FIG. 12C is a diagram illustrating a different perspective of the fluid guidance channel of FIG. 12B, according to some embodiments described in the disclosure.

FIG. 13 is a diagram illustrating a fluid distribution structure that is curved by a further dimension, according to some embodiments described in the disclosure.

FIG. 14 is a diagram illustrating production methods for introducing a channel structure into a fluid distribution element, according to some embodiments described in the disclosure.

### DETAILED DESCRIPTION

The present disclosure relates to a heat exchanger system, including:
a) a fluid distribution element having a central inlet and fluid-sealed, channel-like fluid guide which cascades and branches in a binary manner into a plurality of fluid guidance channels with respectively one fluid outlet,
b) at least one 1 pass heat exchanger which consists of a plurality of through-flowable tubes which are disposed in one plane and have planar partial faces, preferably flat tubes, and also fins which are connected on these planar partial faces to the tubes, and the fins can be flowed round for heat exchange with air, each of the through-flowable tubes disposed in one plane having a tube inlet for a fluid and a tube outlet for a fluid, the tube outlets opening into a fluid collection system, the fluid distribution element having the same number of fluid outlets as the 1 pass heat exchanger has through-flowable tubes, and
c) a direct connection of the fluid distribution element to the 1 pass heat exchanger being produced, each fluid outlet of the fluid distribution element being connected integrally and in a fluid-sealed manner to respectively one tube inlet of a tube of the heat exchanger, or
d) an indirect connection of the fluid distribution element to the 1 pass heat exchanger being produced, each fluid outlet of the fluid distribution element being connected integrally and in a fluid-sealed manner to respectively one tube inlet of a tube of the heat exchanger, the connection being produced via respectively a fluid-sealed, through-flowable connection element or via a connection element with a number of connecting fluid guides which corresponds to the number of fluid outlets and tube inlets to be connected.

Also, the present disclosure relates to a composite of a fluid distribution element and at least one 1 pass heat exchanger, either the fluid distribution element being connected directly to the heat exchanger (direct connection) or else the fluid distribution element being connected to the heat exchanger via corresponding connection elements (indirect connection). In some embodiments, the fluid distribution element has the same number of fluid outlets as the heat exchanger has through-flowable tubes. In this respect, a direct distribution of the fluid via the fluid distribution element and feeding into the 1 pass heat exchanger is possible.

Also, the present disclosure describes a combined concept for the fluid distribution and the connection of a fluid distributor to air-supplied heat exchangers, which heat exchanger consists at least of flat tubes, such as e.g. MPE tubes, and of undulating or bent and cut fins, e.g. made of aluminium sheet. The distributor serves for distribution of mono- or multiphase fluids. The basis of this concept is the connection of channel structures introduced in sheet metal, such as shown in WO 2009/01659, for evaporators in refrigerators or solar absorbers, which can be produced by roll-bonding and expansion of the resulting joined double metal sheet or by active media- or active energy-based reshaping with subsequent joining.

There are included in the active media-based reshaping methods, for example, internal and external high-pressure reshaping methods with liquid and gaseous active media, electrohydraulic reshaping and also gas generator and explosive reshaping. As active energy-based reshaping method, electromagnetic reshaping is possible.

The 1 pass heat exchangers include heat exchangers in which each tube is at the same time a tube register, i.e. no returns in the composite of tubes and lamellae of a tube takes place via bends. In contrast thereto, for example a 2 pass heat exchanger has, per tube register, at least 2 tubes which are returned in the composite of fins and tubes.

The present disclosure serves for combined prefabrication both of the channel structure which distributes fluid and the connection of the flat tubes. In particular for heat exchangers, such as e.g. air-coolant evaporators in refrigeration cycles, a solution strategy for the final manufacture of the heat exchanger becomes possible with this method. The manufactured heat exchanger is combined, in this case, with a fluid distributor which entails a smaller dead volume even in the connection region, which offers an advantageous construction relative to known fluid distributors. These advantages reside in the fact that, on the one hand, a phase separation due to retention of the flow in these dead volumes is reduced to a minimum and, on the other hand, the preformed connection regions for the flat tube are situated in the sheet metal structure separately from each other, which prevents back-mixing of the flow.

With the fluid distributor, these reduction potentials become possible even with the evaporator component. Combination of manufacture of the fluid distributor with and without baffles for controlled orientation and settling of the flow enables direct connection regions for the MPE tube in one workpiece.

The heat exchanger system and the fluid distribution system are suitable for optimising modern evaporator technologies. This thereby concerns above all evaporators for compression refrigeration- or also heat pump units. It solves the key problem of poor distribution of the phases of the coolant in the refrigeration cycles at the inlet of the evaporator of soldered aluminium heat exchangers. The output range is thereby arbitrary, for which reason the application field is very large. As a conservative estimate, compression cold units of the possible refrigeration-producing technologies in the field of cooling and refrigeration production have a market proportion of more than 90%. In the heat production, heat pumps which are operated with the same principle have an increasing market share and altogether a share of 5-10% in the German market with a tendency to increase greatly.

The dead volume of the distributor and in particular of the connection piece can be minimised in this way and consequently promise very low phase separation. Provided that the pressure losses for a specific design of the distributor do not become too great and controllability of the expansion valve in the cold circuit is no longer ensured, the mass flow can be varied, with a small effect on the distribution quality. This is an important step also for enabling, for the evaporator component, robustness for the output-controlled operation. In addition to this direct improvement in the properties as distributor, the use implies a further reduction in the internal volumes of the evaporator. For this reason, this distributor has significant advantages relative to previous distribution approaches for also reducing the reduction of climate-damaging or combustible coolants. In particular, the present invention relates to a special connection technology between fluid distributor and heat-exchanging fin-flat-tube block, i.e. the actual 1 pass heat exchanger. This can thereby concern either a connection region in the same sheet metal component or a separate connection piece. However the latter causes many individual connections between distributor and connection piece, which makes a pressure-sealed construction of the component difficult. However, the advantage resides in the fact that, in the tube intermediate parts, a nozzle (60), which causes spraying of the fluid coming from the distributor at the inlet of the connection region, can be used and inserted. In this way, a phase distribution even at the inlet of the individual flat tube can be controlled. It is also conceivable that these nozzle inserts are situated directly in channels in front of the connection region in the combined component which unites both distributor and connection region.

In some embodiments, the cascaded and binary branching of the fluid guidance channels of the fluid distribution element has a symmetrical configuration. A symmetrical configuration in the fluid distributor provides that each fluid guidance channel is always split into an equal number of fluid guidance channels so that the same pressure loss results for each fluid guidance channel.

The spacings between individual branch planes and/or the length of the branch planes can be adapted for flow settling. It is conceivable, in addition to the mentioned nozzles at the outlet of the fluid distribution element, to use further inserts or specially reshaped regions for flow settling in each branch plane. The accelerated flow alignment or settling can lead to a more compact construction. This affects the total length to a large extent. In this way, the necessary flow path lengths, which ensure homogeneous flow ratios and are advantageous for the distribution process, are reduced.

In some embodiments, the individual branch planes of the fluid distribution channels are at a spacing from each other such that an optimum configuration of the flow form is ensured in the region respectively in front of the next branch plane. In some embodiments, the individual branch points of the cascading of the fluid distribution channels have a minimum spacing from each other which corresponds to five times the hydraulic diameter.

The hydraulic equalisation can be designed more easily in the symmetrical configuration of the branches. However, this is also achievable in an asymmetrical configuration. The difference resides in the fact that, from the branch point in the asymmetrical configuration in the case of the plurality of branches, no uncurved level line exists. In some embodiments, this follows the implementations as described in WO 2004/097323 A1.

According to the present disclosure, the heat exchanger system has at least one 1 pass heat exchanger. In the case where the heat exchanger system comprises merely one heat exchanger, this is embedded between the fluid distribution element and the fluid collection system and is supplied with fluid via the fluid distribution element, whilst the discharge of the fluid is effected via the fluid collection element. In the case where a plurality of heat exchangers is present, the arrangement is effected such that the 1 pass heat exchangers are stacked and are flowed through by air either in the cross-counter- or in the cross-parallel flow. Interleaving of the individual 1 pass heat exchangers is then effected via bends which in turn respectively connect one tube to another. Each 1 pass heat exchanger has hence the same number of flat tubes. Each of these bends must enable a change in flow direction by 180° in order to be supplied, upon re-entry, to the respectively subsequent 1 pass heat exchanger.

In some embodiments, the fluid guidance channels of the fluid distribution element are disposed situated flat in one plane or a bend and/or an elbow by a further dimension.

In some embodiments, the fluid outlet of each fluid guidance channel of a fluid distribution element is configured at the end of the respective fluid guidance channel, i.e. is disposed in the plane in which the fluid flow takes place. However, alternatively hereto, it is likewise possible that the fluid outlet of each fluid guidance channel of one fluid distribution element is introduced in the wall of the respective fluid guidance channel, such as if the fluid outlet is configured as a slot or an oblong hole which can extend over a large part of the length of the last branch plane of each fluid guidance channel. In some embodiments, the fluid flow is deflected, for example by approx. 90 degrees, during exit from the fluid guidance channel.

In some embodiments, the fluid distribution element, which is described further on in detail, can be used in the heat exchanger system according to some embodiments described in the disclosure.

In some embodiments, it is of advantage if the fluid outlet introduced into the wall of the fluid guidance channel has a simple or shouldered projection of the wall of the fluid guidance element, inlet opening or the connection element being connected integrally to the projection. As a result, the penetration depth of inserted flat tubes can be controlled.

Alternatively or additionally hereto, it is likewise possible if the tube inlet of the heat exchanger (provided a direct connection of the heat exchanger to the fluid distributor is produced) or the connection element (provided an indirect connection between heat exchanger and fluid distributor is produced) have respectively, in the region of the connection to be produced to the fluid distributor, a tapering of the respective connection piece, i.e. of the respective tube, so that the respective elements can be inserted in the projection of the fluid distributor. The respective tube inlets or connection elements are thereby connected likewise integrally to the projection of the fluid distribution element.

In some embodiments, in the case of a direct connection of the fluid distribution element to the 1 pass heat exchanger between a fluid outlet of the fluid distribution element and the inlet opening of a corresponding tube of the heat exchanger, a tube base, distributor container, distributor, collection box or a part of the same is disposed.

Alternatively hereto, in the case of an indirect connection of the fluid distribution element to the 1 pass heat exchanger via a connection element, a tube base, distributor container, distributor, collection box or a part of the same is disposed, between the connection element and the inlet opening of the corresponding tube of the heat exchanger.

A previously mentioned collection box can have, for example, a housing with a number of inlets which corresponds to the number of fluid outlets of the fluid distribution element and an equal number of outlets, each inlet being assigned to one outlet and, in the interior of the housing, a sealed channel for the fluid being defined via baffle plates.

The collection box can have, for example, a cylindrical configuration and be composed of two half-shells.

The baffle plates which are disposed in pairs within the housing of the collection box hence form a sealed partial volume of the collection housing which is hence flowed through from the fluid distribution element in the direction of the heat exchanger. The remaining volume region of the collection box is hence not filled by fluid, in the case of a fluid-sealed connection of the baffle plates in pairs to the collection box. This serves in particular for minimising the volume for the fluid in the heat exchanger system.

Such a collection box has in particular a stabilising effect in a production process of each individual 1 pass heat exchanger. In the collection boxes, the prefabricated tube openings both of the fluid distribution element and of the heat exchanger can already be introduced into the corresponding openings and subsequently connected integrally to the collection box. In some embodiments, this is manufactured in a soldering furnace with a controlled atmosphere, the housing of the collection box being halved in order to enable separate integral connection of the fluid distribution element to one half of the collection box and of the 1 pass heat exchanger to the other half of the collection box. Only in a subsequent process step is the collection box connected again integrally. Not, however, in the soldering furnace but rather by a welding method. This enables, on the one hand, a more compact design of the components which are intended to be connected in the soldering line (which is frequently necessary on the basis of restricted dimensions of the soldering line dimensions). On the other hand, the halved collection box is easy to connect, for example to connect by a welding method, since the connection has a small weld (weld length) in relation to the construction volume. It is also conceivable that, in less restricted soldering lines, a complete integral manufacture is effected without halving the collection box.

In the case of such a collection box, it is used in particular if the geometry of the inlets and/or of the outlets of the collection box corresponds to the cross-section of the fluid outlets of the fluid distribution element or to the cross-section of the fluid outlets of the connection element or to the cross-section of the through-flowable tubes with planar partial faces, such as flat tubes of the 1 pass heat exchanger.

Furthermore, it is advantageous if the housing of the collection box or a part of the housing, for example an above-mentioned half-shell of a cylindrical housing is configured in one piece with the fluid outlets 23 of the fluid distribution element. Such a one-piece configuration of the housing of the collection box or of a part of the housing of a corresponding collection box can be produced, for example, by deep-drawing methods or high-pressure reshaping etc.

Further advantages can be produced if the connection elements which connect the fluid distribution element and heat exchanger to each other are bent or curved. A further saving in space of the 1 pass heat exchanger system can hereby be effected.

Furthermore, it is advantageous if the connection element is designed similarly to the oblong holes or slots, described further back, and hence similarly to a direct connection of the 1 pass heat exchanger to the fluid distribution element. In this way, analogously to the use, in pairs, of the baffle plates in a cylindrical and possibly halved collection box, a prefabricated composite of connection element and 1 pass heat exchanger can be produced, which can be integrated more easily from a procedural point of view in a manufacturing process with a soldering line.

The present disclosure also relates to a method for the production of a previously described heat exchanger system, in which:
a) the fluid distribution element, the heat exchanger and also possibly the tube base, the distributor container, the distributor-, the collection box or a part of the same, or
b) the fluid distribution element, the heat exchanger and the connection elements and also possibly the tube base, the distributor container, the distributor, the collection box or a part of the same are joined in a form fit and also connected to each other integrally and in a fluid-sealed manner.

In some embodiments, the integral and fluid-sealed connection is effected by a soldering process.

Also, the disclosure relates to a fluid distribution element which has a central inlet and a fluid-sealed, channel-like fluid guide which cascades and branches in a binary manner into a plurality of fluid guidance channels with respectively one fluid outlet, the fluid outlet of each fluid guidance channel being introduced into the wall of the fluid guidance channel.

In some embodiments of the fluid distribution element, reference is made to the above embodiments made of the fluid distribution element contained in the 1 pass heat exchanger system according to the disclosure. All of the embodiments there for this fluid element are also the subject of the fluid distribution element according to the disclosure.

In some embodiments of the fluid distribution element according to the present disclosure, the cross-section of the fluid guidance channel is enlarged at least in the region of the fluid outlet, in comparison with the cross-section of the fluid guidance channel in the region of the cascading, in the case of the direct connection of fluid distribution element and 1 pass heat exchanger. As a result, for example, the insertion depth of inserted flat tubes can be varied, on the one hand.

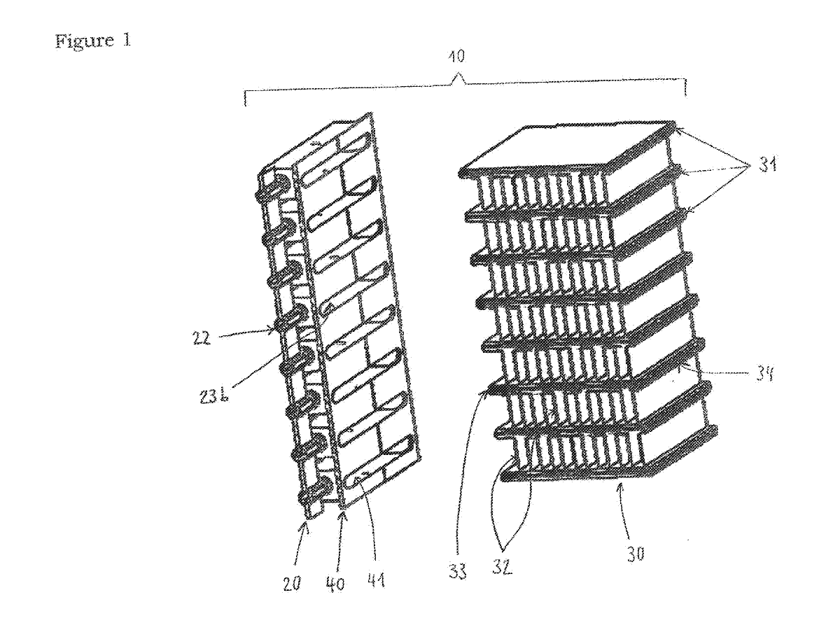

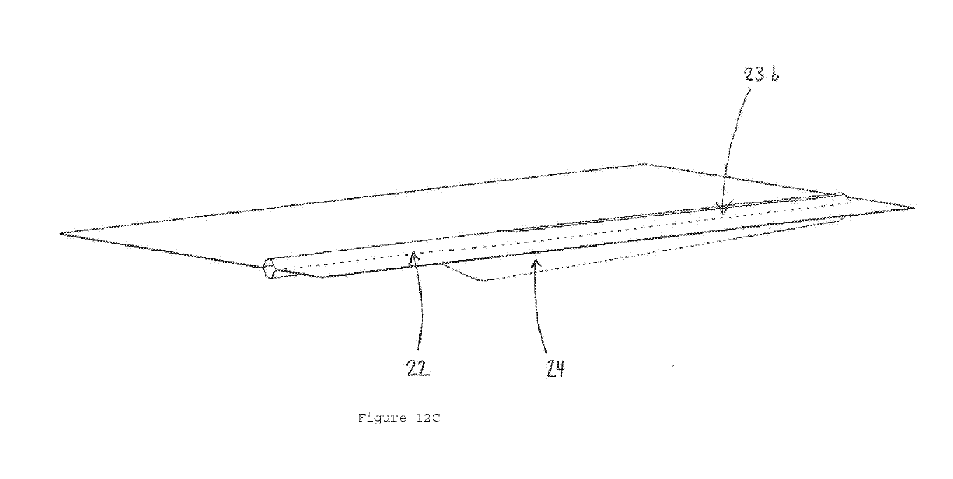

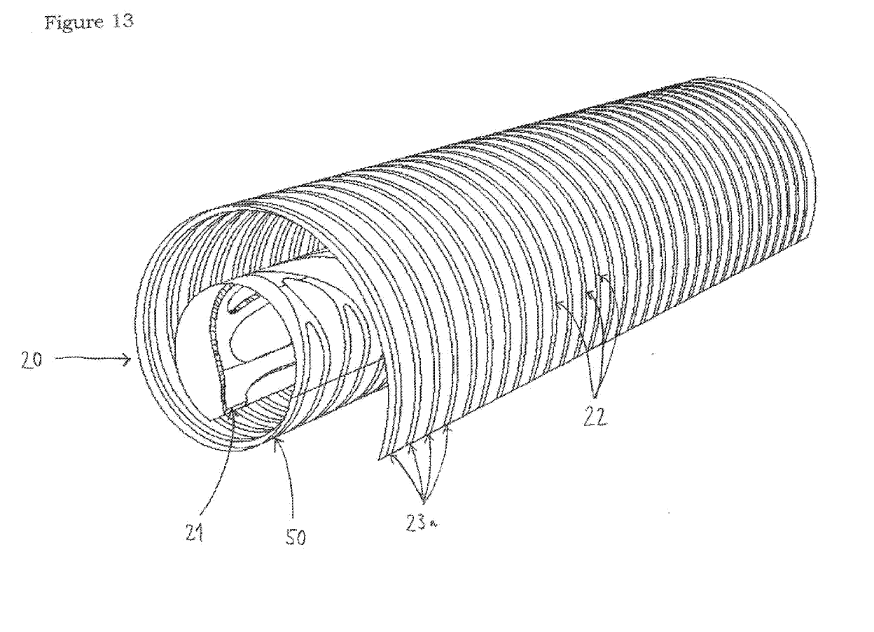

FIG. 1 is a diagram illustrating an indirect connection of a fluid distribution element 20, a 1 pass heat exchanger 30 and a connection element 40 for the entire 1 pass heat exchanger system 10, according to embodiments of the present disclosure. The fluid distribution element 20 thereby comprises a large number of parallel-guided fluid guidance channels 22; the central inlet 21, the branches to the in total 8 represented fluid guidance channels 22 and also the fluid collection system or element, disposed on the outlet side, are not illustrated in FIG. 1. The connection element in this embodiment consists of one part but comprises a connection for each outlet opening of the fluid distribution element and also of each tube of the 1 pass heat exchanger. Like FIGS. 12A-12C, this enables a connection of the heat exchanger to the openings in the form of oblong holes or slots.

Each one of the fluid guidance channels 22 of the fluid distribution element 20 thereby has respectively one fluid outlet 23b which, in the case of FIG. 1, is introduced into the wall of each fluid guidance channel 22. The outline of the aperture of the opening of these fluid outlets 23b corresponds to those of the flat tubes 33 of the 1 pass heat exchanger (30) so that the 1 pass heat exchanger 30 can be inserted in a form fit in the fluid distribution element 20.

The 1 pass heat exchanger 30 is thereby constructed from a plurality of flat tubes 31 which extend parallel to each other and are connected to each other respectively via air cooling lamellae 32. The tubes 31 can be subjected to a flow of fluid over one side 33 (tube inlet), the flat tubes 34 have a fluid outlet 34 on the opposite side. The fluid inlets 33 of the 1 pass heat exchanger 30 protrude slightly beyond the fins 32 so that the projecting length can be introduced into the respective fluid outlets 23b of the fluid distribution element 20. A connection between fluid distribution elements 20 and 1 pass heat exchanger 30 can be produced for example by means of a soldering method.

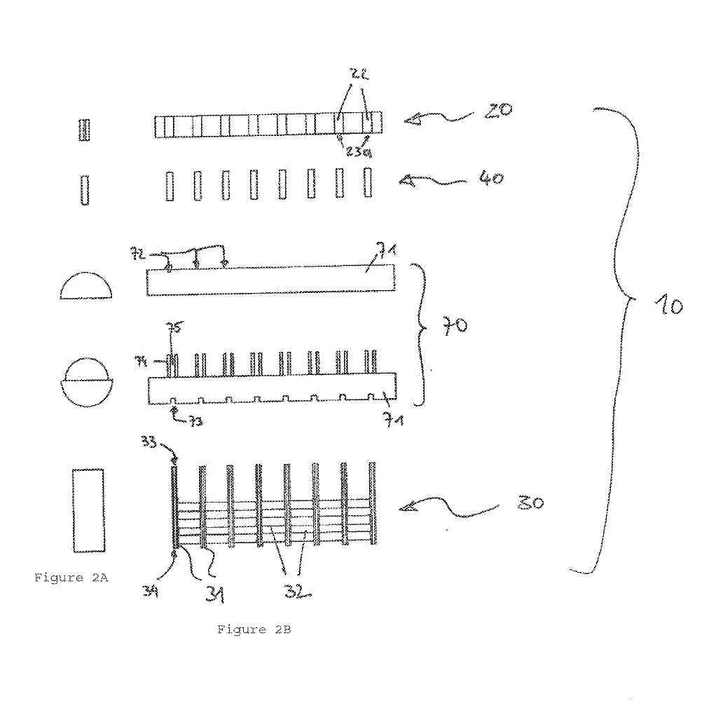

FIGS. 2A and 2B are diagrams illustrating a schematic illustration of further embodiments of a 1 pass heat exchanger system 10, according to the present disclosure. In FIGS. 2A and 2B, two perspective illustrations are indicated, the perspective of FIG. 2A illustrating a view of FIG. 2B in the drawing plane from the left.

The 1 pass heat exchanger system 10, as illustrated in FIGS. 2A and 2B, is formed from a fluid distribution element 20, a 1 pass heat exchanger 30 and also connection elements 40 and a collection box 70 disposed between fluid distribution element 20 and 1 pass heat exchanger 30.

The fluid distribution element 20 thereby has once again a large number of parallel-guided fluid distribution channels 22 with fluid outlet openings 23a which are fitted respectively at the end of the fluid distribution channel. The connection elements (40) can be introduced into these outlet openings 23a and can be connected to the channels 22, for example by soldering methods.

The 1 pass heat exchanger 30 is designed analogously to that illustrated in FIG. 1. As transition between fluid distribution element 20 and heat exchanger 30, a collection box which consists of a housing 71 and also baffle plates 74 fitted in the housing is fitted. As a result of the baffle plates 74 which are fitted in pairs, a sealed channel 75 is produced within the collection box (70). The housing (71) of the collection box 70 has a plurality of inlet openings 72 which are provided at places into which the connection elements 40 are to be connected to the collection box 70 or to be introduced into the latter. The baffle plates 74 are thereby disposed within the collection box 70 preferably such that the fluid flow which enters into the collection box 70 from the distribution elements 40 is introduced directly into the sealed channels 75. The housing part 71 disposed on the other side of the collection box 70 thereby has a plurality of outlet openings 73 via which the fluid conducted by the flow channels 75 can emerge from the collection box 70. Also the fluid inlet openings 33 of the fluid distribution element 30 can be introduced or inserted into these openings 73. The total composite of the individual components can likewise be connected together for example by a soldering method. A connection of partial composites is just as possible. Preferably, the fluid distribution element 20, the connection elements 40 and also the half of the collection box 71 with the connections for the connection elements 72 are processed as partial composite and also the heat exchanger 30 with the other half of the collection box 71 with the connections 73 for the tubes and optionally the baffle plates 74 in pairs.

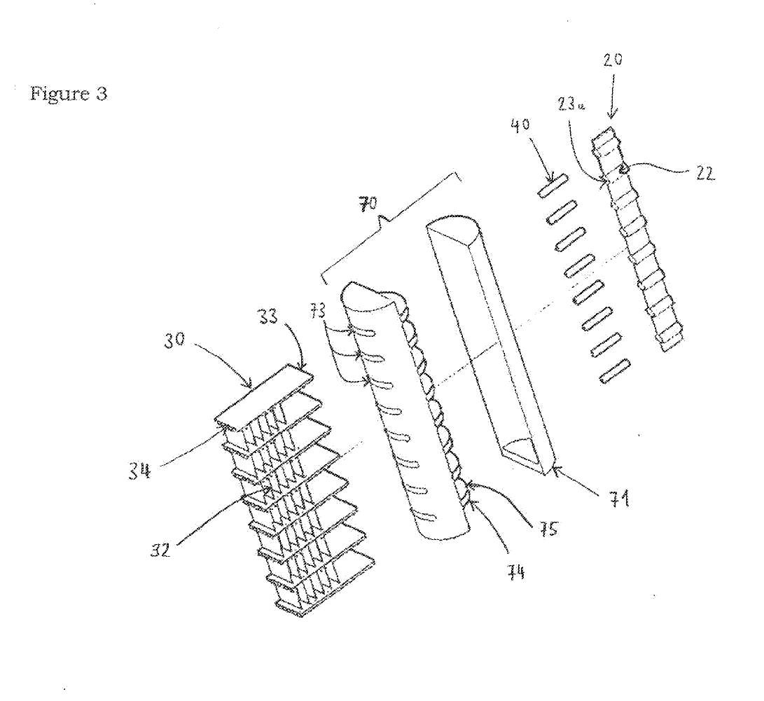

FIG. 3 is a diagram illustrating an exploded view of FIGS. 2A and 2B in perspective illustration, the same reference numbers representing the same elements.

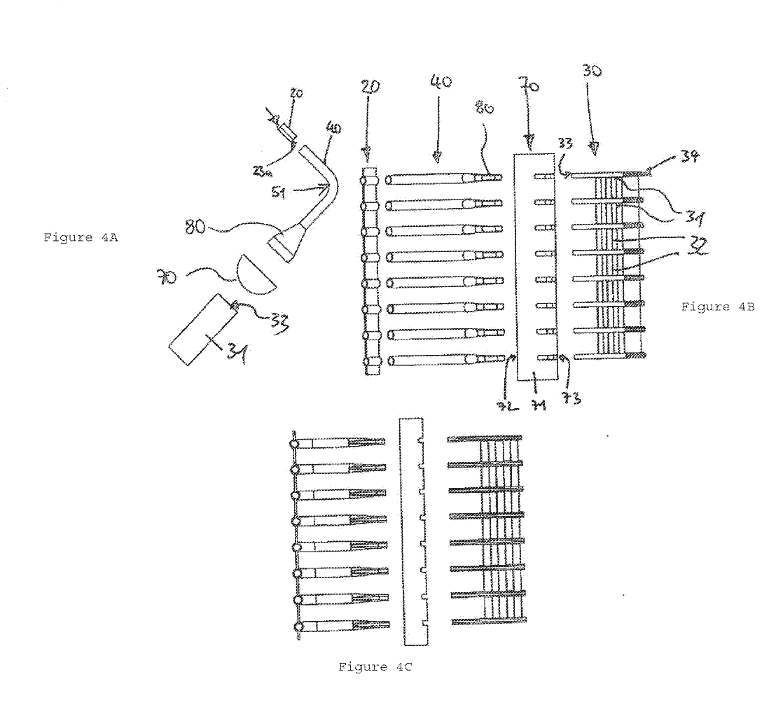

Embodiments of the 1 pass heat exchanger system according to the disclosure are illustrated in FIGS. 4A-4C. These embodiments are similar to the embodiments illustrated in FIG. 3; here also, connection elements 40 are disposed between the fluid distribution element 20 and the heat exchanger 30. FIG. 4A is a diagram illustrating a plan view on the 1 pass heat exchanger system, according to embodiments of the present disclosure. FIG. 4B is a diagram illustrating a schematic exploded view of this system, according to embodiments of the present disclosure. FIG. 4C is a diagram illustrating the partial assembly of the fluid distribution element 20 and of the connection elements 40, according to embodiments of the present disclosure. In FIGS. 4A-4C, the distribution elements 40 have a bend 51 and are equipped with a transition region 80 in which the originally round cross-section of the connection element changes into a flattened tube cross-section. In this respect, a direct connection of this end portion 80 to the flat tubes 31 of the heat exchanger is possible. The baffle plate 70 illustrated in the Figures thereby serves for stabilisation of the merger between the outlet openings 80 of the connection elements and the inlet openings 33 of the heat exchanger. It is conceivable here that, for the manufacture of the composite of heat exchanger 30 and collection box 70, also the connection elements are soldered in one method step, and only the connection to the fluid distribution element 20 is effected in a subsequent method step in order to keep the dimensions compact for the processing in the soldering line.

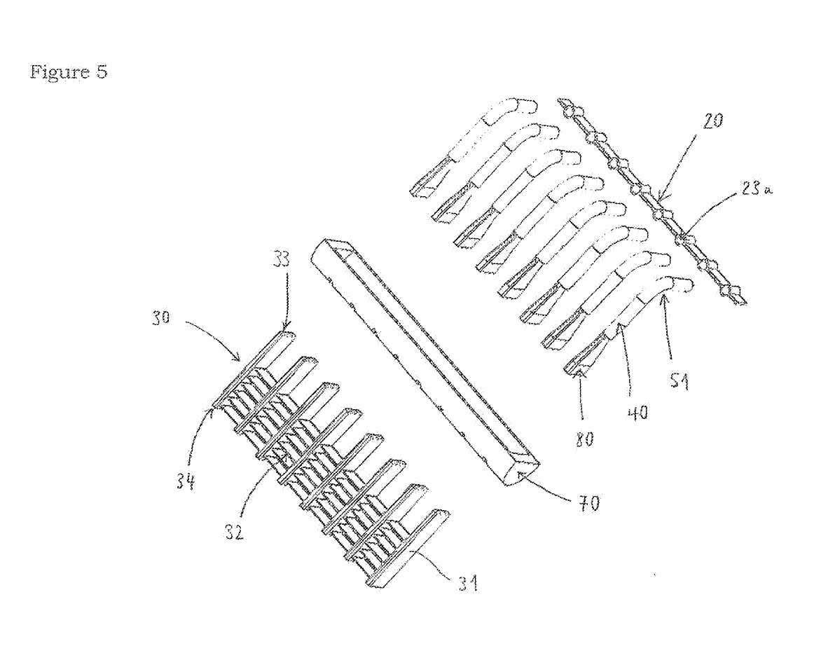

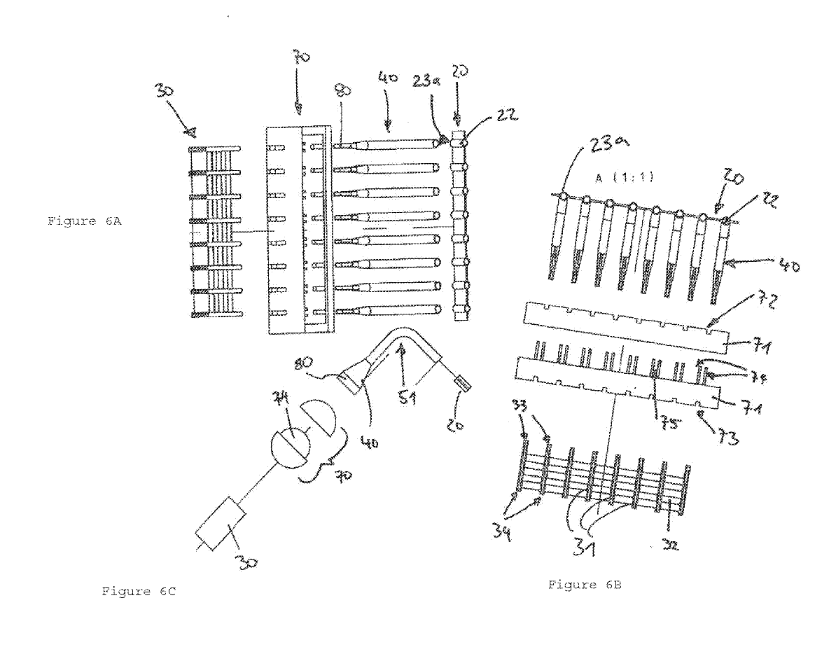

FIG. 5 is a diagram illustrating embodiments illustrated schematically in FIGS. 4A-4C in a perspective illustration, the same reference numbers denoting the same elements.

FIGS. 6A-6C are diagrams illustrating embodiments that essentially correspond to a combination of the embodiments as illustrated in FIGS. 2A and 2A and FIGS. 4A-4C. FIG. 6A is a diagram illustrating an exploded view of 1 pass heat exchanger system, according to some embodiments described in the disclosure. FIG. 6B is a diagram illustrating another exploded view of a 1 pass heat exchanger system, according to some embodiments described in the disclosure. FIG. 6C is a diagram illustrating a plan view of a 1 pass heat exchanger system, according to some embodiments described in the disclosure. Once again a fluid distributor 20, connection elements 40, a collection box 70 and also a 1 pass heat exchanger which can be combined to form the overall 1 pass heat exchanger system are illustrated. The collection box 70 is configured, as illustrated in FIGS. 2A and 2B, in addition the connection elements 40 are configured at an angle 51 and, as illustrated for example in FIG. 6C, have a bend at a right angle.

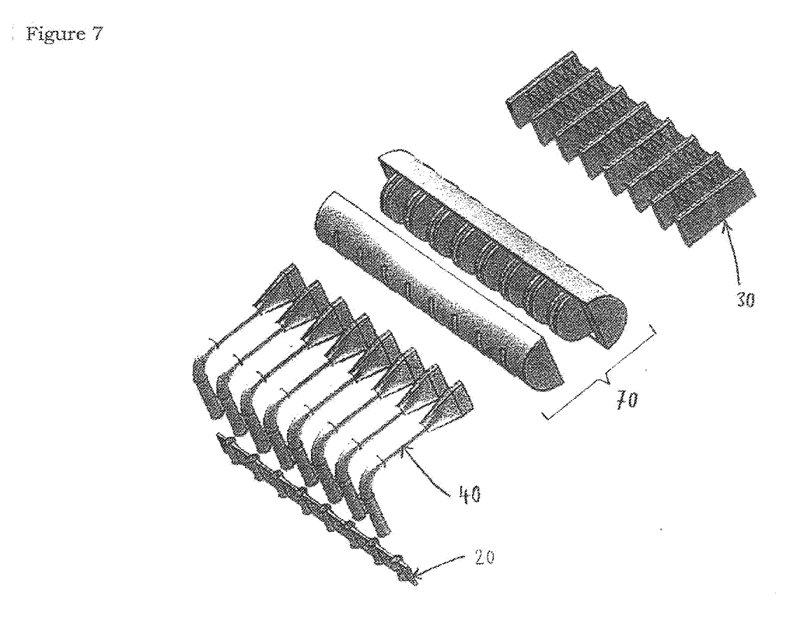

FIG. 7 is a diagram illustrating a corresponding 1 pass heat exchanger system of that described in FIG. 6, the same reference numbers denoting the same elements.

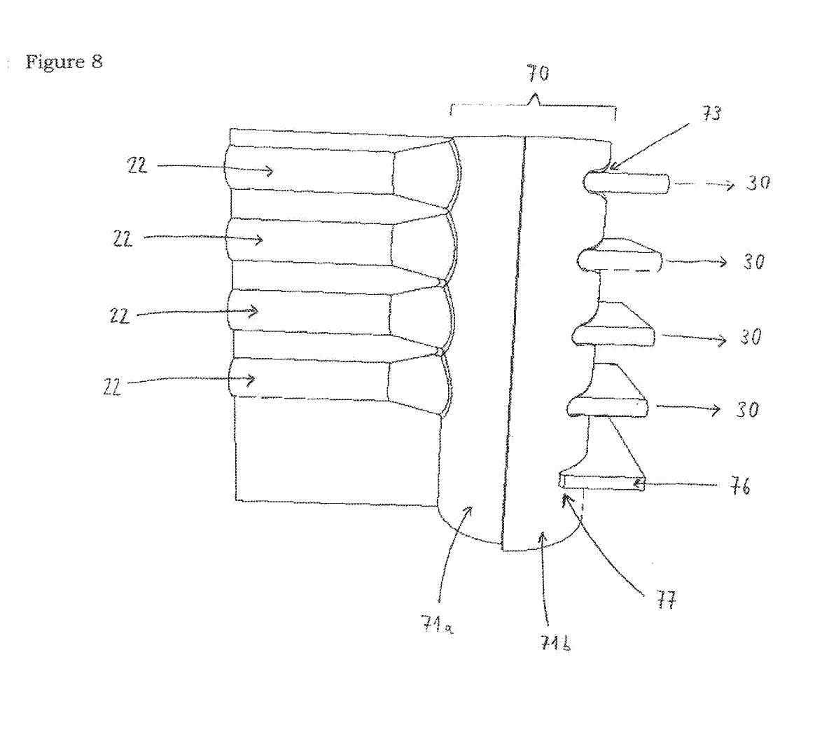

FIG. 8 is a diagram illustrating a section of a connection of fluid outlets 23 of a fluid distribution element 20 to a collection box 70, via a collection box 70 to a 1 pass heat exchanger, according to embodiments of the present disclosure. The two half-shells of the collection box 70 forming the housing 71 can be readily detected. The fluid guidance channels 22 are thereby configured in one piece with the collection box 70, the inlet openings of the heat exchanger 30 are inserted into the outlet openings 73 on the opposite side of the collection box 70.

The collection box 70 according to FIG. 8 has in addition an opening into which a fixing element 76, for example a solid metal piece or a correspondingly shaped metal sheet, can be inserted, via which the collection box 70 together with the joined further elements can be fixed during the production process, i.e. during connection of all the elements, for example via a soldering process. These embodiments are conceivable for fixing, in the unattached state of tubes and fins, and for processing in the soldering line, generally for each of the embodiments of the 1 pass heat exchanger.

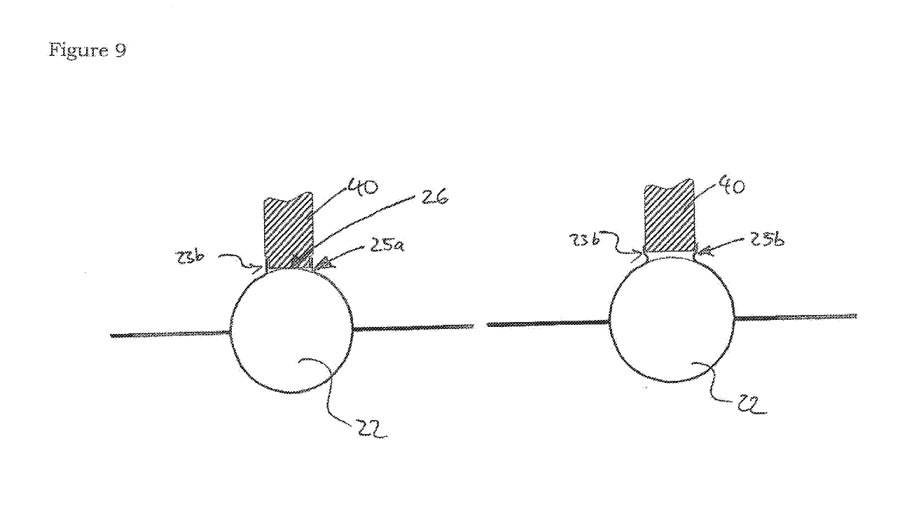

FIG. 9 is a diagram illustrating embodiments of fluid guidance channels 22 of a fluid distribution element 20 in which the fluid outlets 23b are inserted into the wall of the fluid guidance channel 22, according to embodiments of the present disclosure. These fluid outlet channels can be configured for example as oblong holes or in corresponding slots. For example, a connection element 40 can be inserted in a form fit in these outlet openings 23b. In the region in which it is connected to the fluid guidance channel 22, the connection element 40 has a tapering 26 of the cross-section. Illustrated on the left in FIG. 9 is an embodiment which illustrates a simple collar 25a; the wall of the fluid guidance channel is hereby adapted correspondingly to the diameter of the connection element. Illustrated on the right in FIG. 9 is an embodiment which has a shouldered collar 25b, the projection is hereby slightly notched so that a certain spacing can be produced between the connection element 40 and the fluid guidance channel 22. Instead of the connection element 40, also a 1 pass heat exchanger 30 (not illustrated) can however likewise be introduced directly into the projection. Such embodiments are illustrated for example in FIGS. 12A-12C.

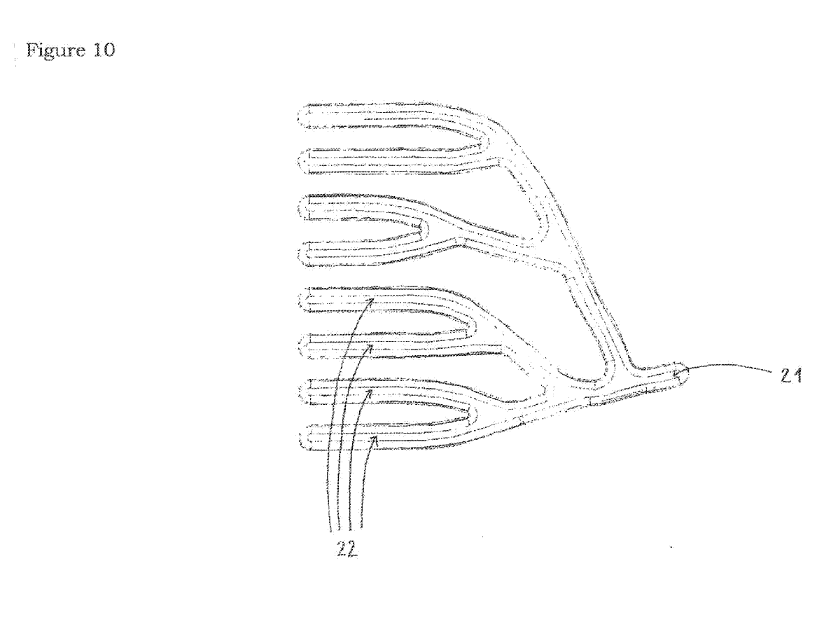

FIG. 10 is a diagram illustrating a lower metal sheet of a fluid distribution structure 20, by way of example, in IHB manufacturing mode, according to embodiments of the present disclosure. The fluid distribution element has a common fluid inlet 21; an asymmetrical distribution of the individual channels to various fluid distribution channels 22 which should have a preferably mirror-symmetrical configuration is effected in order to simplify the distribution process. The fluid distribution element is provided by a corresponding upper metal sheet.

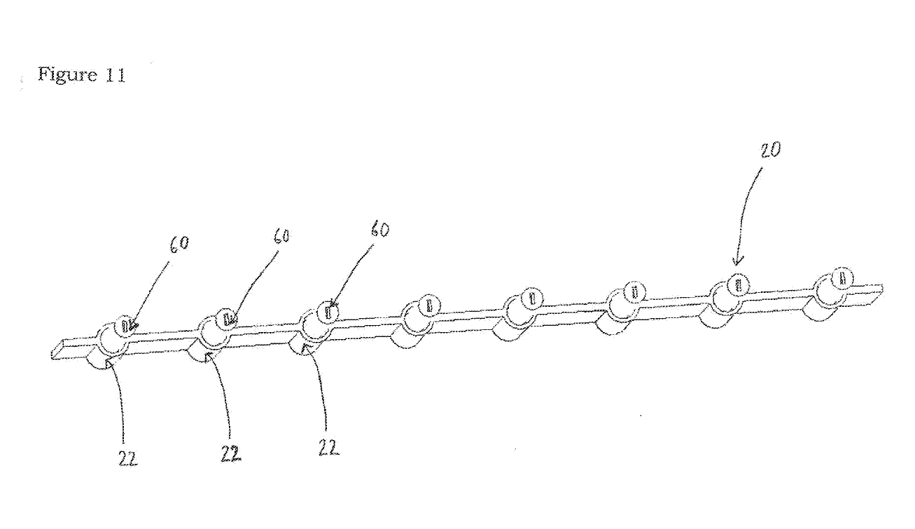

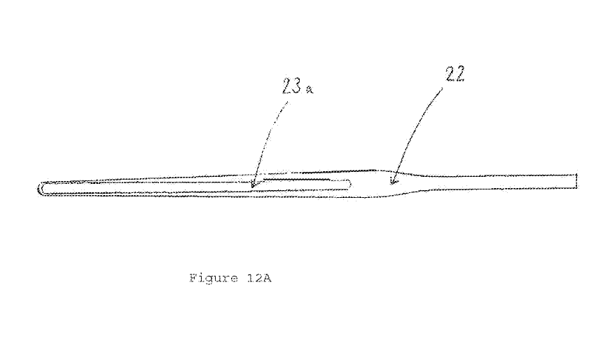

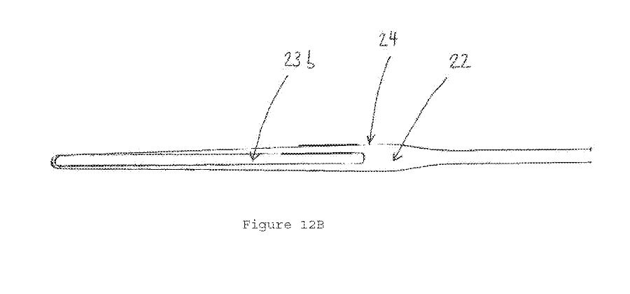

FIG. 11 is a diagram illustrating a fluid distribution element in which nozzles 60 are attached directly to the outlet opening of the fluid distribution channels 22 in order to influence the fluid flow and/or the condensation or evaporation behaviour of the through-flowing fluid, according to embodiments of the present disclosure.

FIG. 12A is a diagram illustrating an individual fluid guidance channel 22 into which an oblong hole 23b is introduced into the wall of this channel, according to embodiments of the present disclosure. The fluid guidance channel 22 is thereby flowed through with fluid from right to left in FIGS. 12A-12C, the fluid leaving the fluid guidance channel 22 perpendicular to the image plane at the top through the oblong hole 23b.

The widening of the fluid guidance channel 22 configured in the region of the oblong hole 23b can be readily detected in the plan view from above. In this region, the fluid guidance channel 22 has a widened or enlarged tube cross-section. The widening 24 of the average of the fluid guidance channel 22 is thereby configured in addition directly in front of the region of the oblong hole.

FIG. 12C shows a different perspective illustration of the fluid guidance channel 22 which is illustrated in FIG. 12B, the perspective illustration illustrated in FIG. 12C corresponds to a view of the image, illustrated in FIG. 12B, looking from the top onto the fluid guidance channel 22 in the image plane. In the perspective illustrated in FIG. 12C, the oblong hole 23b is configured at the top on the fluid guidance channel. It is likewise detectable that the fluid guidance channel or the entire structure is produced by connection of two metal sheets by means of a joining method. In addition, it is detectable that the widening 24 of the fluid guidance channel is configured in particular also in the lower-lying metal sheet of the fluid guidance channel 22 so that the fluid guidance channel 22, in the region opposite the oblong hole 23b, has a type of depression. As a result of this depression, it is ensured, on the one hand, that the insertion depth of flat tubes inserted into the oblong hole 23b can be varied. On the other hand, also the flow of the fluid can be improved by such a depression 24.

FIG. 13 is a diagram illustrating a fluid distribution structure 20 which is curved by a further dimension 50, according to embodiments of the present disclosure. Also such a distribution structure is suitable for the production of a 1 pass heat exchanger system according to the present disclosure.

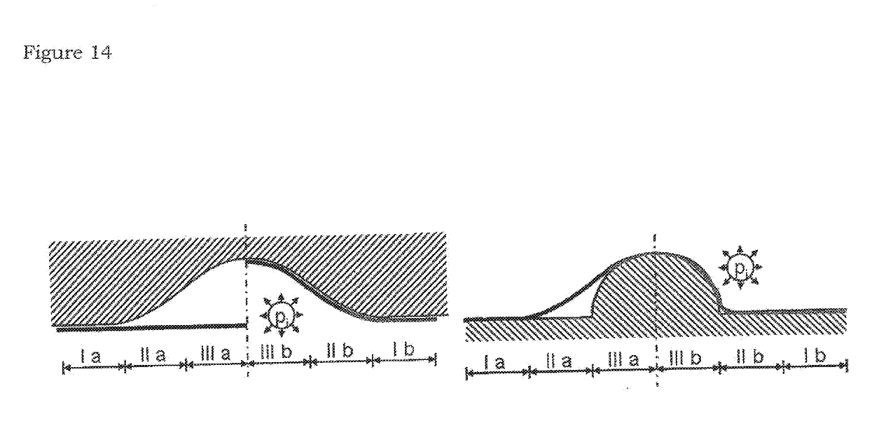

FIG. 14 is a diagram illustrating production methods for introducing a channel structure into a fluid distribution element, according to embodiments of the present disclosure. The channel structure is shaped in two steps with the help of active media and/or active energy in combination with a shape-memory tool, the shaping direction or the position of shapeless media and shape-memory elements with respect to the component to be shaped being reciprocal. As a result of the reciprocal mode of operation, the starting material is thinned in all three zones I, II and III, which allows, in addition to a uniform final wall-thick distribution, a reduced starting wall thickness (material efficiency, lightweight construction) and in addition a better geometric shaping of a semi-circular fluid channel. FIG. 14 represents embodiments of the two-step process, the starting situation being illustrated per step in the left-hand half and the end situation of the step in the right-hand half.

The reshaping methods of such metal sheets can be effected in particular by internal high pressure deformation methods, in particular fluids are hereby used. The hatched regions illustrated in FIG. 14 represent a type of template, via which the metal sheets (black continuous lines) can be inserted into the template tool means via pressure. Two variants are hereby conceivable, on the one hand, a negatively shaped template (FIG. 14, left part), and also a positively shaped template (FIG. 14, right part).

Various modifications and additions can be made to the embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

1.-14. (canceled)

15. Heat exchanger system, comprising:
a fluid distribution element having a central inlet and fluid-sealed, channel-like fluid guide which cascades and branches in a binary manner into a plurality of fluid guidance channels with respectively one fluid outlet; and
at least one 1 pass heat exchanger which consists of a plurality of through-flowable tubes which are disposed in one plane and have planar partial faces, preferably flat tubes, and also fins which are connected on these planar partial faces to the tubes, and the fins can be flowed round for heat exchange with air, each of the through-flowable tubes disposed in one plane having a tube inlet for a fluid and a tube outlet for a fluid, the tube outlets opening into a fluid collection system,
the fluid distribution element having the same number of fluid outlets as the 1 pass heat exchanger has through-flowable tubes and
a direct connection of the fluid distribution element to the 1 pass heat exchanger being produced, each fluid outlet of the fluid distribution element being connected integrally and in a fluid-sealed manner to respectively one tube inlet of a tube of the heat exchanger, or
an indirect connection of the fluid distribution element to the 1 pass heat exchanger being produced, each fluid outlet of the fluid distribution element being connected integrally and in a fluid-sealed manner to respectively one tube inlet of a tube of the heat exchanger, the connection being produced via respectively a fluid-sealed, through-flowable connection element or via a connection element with a number of connecting fluid guides which corresponds to the number of fluid outlets and tube inlets to be connected.

16. The heat exchanger system according to claim 15, wherein the cascaded and binary branching of the fluid guidance channels of the fluid distribution element has a symmetrical configuration.

17. The heat exchanger system according to claim 15, wherein the fluid guidance channels of the fluid distribution element are disposed situated flat in one plane or have a bend and/or an elbow by a further dimension.

18. The heat exchanger system according to claim 15, wherein the fluid outlet of each fluid guidance channel is configured at the end of the respective fluid guidance channel or is introduced into the wall of the fluid guidance channel, configured as a slot or an oblong hole.

19. The heat exchanger system according to claim 18, wherein the fluid outlet introduced into the wall of the fluid guidance channel has a simple or shouldered projection of the wall of the fluid guidance element and/or the tube inlet or the connection element has a tapering cross-section, the tube inlet or the connection element being connected integrally to the projection.

20. The heat exchanger system according to claim 15, wherein the fluid outlet of the fluid distribution element and/or the fluid-sealed, through-flowable connection element has a nozzle for influencing the flow profile of the fluid.

21. The heat exchanger system according to claim 15, wherein in the case of a direct connection of the fluid distribution element to the 1 pass heat exchanger between a fluid outlet of the fluid distribution element and the tube inlet of a corresponding tube of the heat exchanger, or in the case of an indirect connection of the fluid distribution element to the 1 pass heat exchanger via a connection element between the connection element and the tube inlet of the corresponding tube of the heat exchanger, a tube base, distributor container, distributor, collection box or a part of the same is disposed.

22. The heat exchanger system according to claim 21, wherein the collection box has a housing with a number of inlets which corresponds to the number of fluid outlets of the fluid distribution element and an equal number of outlets, each inlet being assigned to one outlet and, in the interior of the housing, a sealed channel for the fluid being defined via baffle plates.

23. The heat exchanger system according to claim 22, wherein the geometry of the inlets and/or of the outlets of the collection box corresponds to the cross-section of the fluid outlets of the fluid distribution element or to the cross-section of the fluid outlets of the connection element or to the cross-section of the through-flowable tubes with planar partial faces, preferably flat tubes of the 1 pass heat exchanger.

24. The heat exchanger system according to claim 15, wherein the housing or a part of the housing of the collection box is configured in one piece with the fluid outlets of the fluid distribution element or with the connection elements.

25. The heat exchanger system according to claim 15, wherein the connection elements are bent or curved.

26. A method for the production of a heat exchanger system, in which a fluid distribution element, a heat exchanger and connection elements, and a tube base, a distributor container, a distributor, a collection box or a part of the same are joined in a form fit and connected to each other integrally and in a fluid-sealed manner.

27. The method according to claim 26, wherein the integral and fluid-sealed connection is effected by a soldering process.

28. A fluid distribution element comprising:
a central inlet; and
a fluid-sealed, channel-like fluid guide which cascades and branches in a binary manner into a plurality of fluid guidance channels with respectively one fluid outlet, wherein the fluid outlet of each fluid guidance channel is introduced into the wall of the fluid guidance channel and the cross-section of the fluid guidance channel is enlarged in the region of the fluid outlet, in comparison with the cross-section of the fluid guidance channel in the region of the cascading.
